(19) United States
(12) Patent Application Publication
(10) Pub. No.: US 2014/0270560 A1
(43) Pub. Date: Sep. 18, 2014

(54) METHOD AND SYSTEM FOR DYNAMIC COMPRESSION OF IMAGES

(71) Applicant: Kadari Subbarao Sudeendra Thirtha KOUSHIK, Bangalore (IN)

(72) Inventor: Kadari Subbarao Sudeendra Thirtha KOUSHIK, Bangalore (IN)

(21) Appl. No.: 13/801,058

(22) Filed: Mar. 13, 2013

(51) Int. Cl. G06T 9/00

(52) U.S. Cl. CPC G06T 9/007
USPC 382/248

(57) ABSTRACT

The embodiment provides a method for temporal compression of one or more images. The method includes receiving the one or more images, performing temporal compression on the one or more images, and generating one or more compressed images using the temporal compression.

The present application is based on, and claims priority from, IN Application Number 4949/CHE/2012, filed on 27 Nov. 2012, the disclosure of which is hereby incorporated by reference herein.

### TECHNICAL FIELD

The embodiments herein relate to the field of image compression, and more particularly to a temporal image compression technique for related and unrelated still images.

### BACKGROUND

Most of the consumer/embedded devices, such as digital cameras, smart phones, tablets, handy cams, surveillance systems, and other devices exhibit digital image capture capabilities with limited storage capacity. Due to increase in demand of digital photography and ever growing resolutions, the digital images may require more storage space. When the storage space of these devices gets full, further images cannot be stored. A user may release the storage space by deleting or transferring some of the images to other devices or may add/replace the existing storage with another storage device. However, such processes may be time consuming and expensive due to requirement of additional hardware components.

In light of above discussion, there remains a need of a robust method and system for compressing digital images so that surveillance systems and other consumer/embedded devices can store more number of images at a reasonable system size and cost.

### BRIEF DESCRIPTION OF THE FIGURES

The embodiments herein will be better understood from the following detailed description with reference to the drawings, in which:

FIG. 1 illustrates generally, among other things, a functional overview of a system for temporal compression of one or more images, according to the embodiments disclosed herein;

FIG. 2 is a block diagram illustrates generally, among other things, component of the system as shown in the FIG. 1, according to the embodiments disclosed herein;

FIG. 3 is a flowchart illustrates generally operations performed for temporal compression of the one or more images, according to the embodiments disclosed herein; and

FIG. 4 illustrates a computing environment implementing the method and system as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for temporal compression of still images. The method includes receiving one or more images from a user. The one or more images described herein can be related images (such of same data format) or unrelated images (such as of different data formats). A temporal compression technique can be performed on the received one or more images to generate one or more compressed images. The one or more compressed images can be significantly less in size than a size of the original one or more images.

The proposed system and method is robust, in expensive, and reliable for compressing the digital images and reducing its storage size to a large extent such that more number of images can be stored at a reasonable system size and cost. The present system and method provides a minimal and non-noticeable lossy compression such that a user (or any untrained eye) cannot notice any difference in quality of the compressed image when compared with the original. Further, the user can easily attach the compressed images (or reduce sized images) and send across a communications network which can further saves bandwidth of the communications network.

FIG. 1 illustrates generally, among other things, a functional overview 100 of a system 102 for temporal compression of one or more images, according to the embodiments disclosed herein. The system 102 can be configured to include/couple with components such as camera, display unit, input/output devices, and the like to capture and manage the images. In an embodiment, the system 102 can be configured to interface with various remote devices 104 such as to receive, store, transfer, manage, display, view, provide, and the like, the one or more images over a communications network 106. In an embodiment, the remote devices 104 described herein can include external cameras, surveillance systems, remote computers, hand held devices, or any other consumer electronic devices. In an embodiment, the communications network 106 described herein can include a wireless communications network, a wire line communications network, a cellular network, the Internet, Global System for Mobile Communication (GSM) network, combination thereof, or any other communications network.

FIG. 2 is a block diagram illustrates generally, among other things, component of the system 102 as shown in the FIG. 1, according to the embodiments disclosed herein. The system 102 can be configured to include a communications module 202, a controller module 204, a storage module 206, and an input/output module 208. Further, the system 102 can include/couple to other modules (not shown) such as a camera module, user interface module, display module, and the like to capture and mange digital images via the system 102.

In an embodiment, the communications module 202 described herein can be configured to transmit/receive one or more images over the communications network 106. The communications module 202 can be configured to allow a user to select/provide the one or more images for compression. Further, the communications module 202 can include capabilities to interact/communicate with various remote devices 104 over the communications network 106 to automatically receive the images.

In an embodiment, the controller module 204 can be configured to include a conventional image compression technique algorithm, preferably a temporal compression technique/algorithm to compresses the one or more images. The temporal compression technique described herein can include a H.264, MPEG2, MPEG4, and any other standard scheme. In an embodiment, the controller module 204 can be configured to include any type of compression technique capable of processing a minimal and non-noticeable lossy compression of the one or more images and resulting in a significantly lesser size compressed images. Since the compression hardware and software components are well known to persons of ordinary skill in the art, so the units, blocks, steps, acts, components, and aspects which are germane to this embodiment are only described. In an embodiment, the temporal compression technique described herein can be used to compress both related and unrelated images. In an embodiment, the term “related images” described herein can include the images of same data format. In an embodiment, the term “unrelated images” described herein can include the images of different data formats or any other type of images. The one or more images described herein can be still images, sequence of images from video, dynamic images, or any other type images.

In an embodiment, the controller module 204 can be configured to perform the temporal compression on the one or more received/selected images. The controller module 204 can be further configured to generate one or more compressed images based on the temporal compression performed on the one or more images. In an embodiment, the one or more compressed images generated by the controller module 206 can require a significantly lesser storage space than the storage space required for the original one or more images. The main advantage of performing temporal compression on the images is to significantly reduce the images storage space so that the user can store more number of images in the system 102. In an embodiment, the one or more compressed images can include a minimal and non-noticeable lossy compression, which may be difficult (or mostly not possible) for the user (or an untrained eye) to notice any difference in quality of the compressed images.

In an embodiment, the storage module 206 can be configured to store the one or more compressed images. The stored images can be imported/exported from/to the remote devices 104 over the communications network 106. Further, the storage module can be configured to include instructions and other data required to process the temporal algorithm on the images.

In an embodiment, the input/output module 208 can be configured to provide input and output interface to the user(s). The input/output module 208 can be configured to include interfaces to various channels, modules, components, remote devices, and units of the system 102 such as to capture/mange images, receive input data, output/display data, and the like.

FIG. 3 is a flowchart illustrates generally operations or method 300 performed for temporal compression of the one or more images, according to the embodiments disclosed herein. In an embodiment, at 302, the method 300 includes receiving one or more images for compression. In an example, the system 102 can allow the user to select the one or more images or the system 102 can automatically receive the one or more images from any local or remote devices.

In an embodiment, at 304, the method 300 includes performing temporal compression on the one or more images. In an example, the controller module 204 can allow the user to perform temporal compression on the images. The temporal compression described herein can include a H.264, MPEG2, MPEG4, and any other standard scheme.

In an embodiment, at 306, the method 300 includes generating one or more compressed images. In an example, in response to performing the temporal compression, the controller module 204 can generate the one or more compressed images. The one or more compressed image can require a significantly lesser storage space than that of the original one or more images. The one or more compressed images can include a minimal and non-noticeable lossy compression, which may be difficult (or mostly not possible) for the user (or an untrained eye) to notice any difference in quality of the compressed images.

In an embodiment, at 308, the method 300 includes previewing the one or more compressed images. In an example, the controller module 204 can allow the user to review the one or more compressed images such that the user can reject, delete, or store the compressed images.

In an embodiment, at 310, the method 300 includes storing the one or more compressed images. In an example, the storage module 206 can store the one or more images, which can be further imported or exported by the local/remote devices over the communications network 106.

The various steps, blocks, or acts described with respect to the FIG. 3 can be performed in sequential order, in random order, simultaneously, parallel, or a combination thereof. Further, in some embodiments, some of the steps can be omitted, skipped, or added without departing from the scope of the embodiment.

FIG. 4 illustrates a computing environment implementing the method and systems as disclosed in the embodiments herein. As depicted the computing environment 402 comprises at least one processing unit 404 that is equipped with a control unit 406 and an Arithmetic Logic Unit (ALU) 408, a memory 410, a storage unit 412, plurality of networking devices 414 and a plurality Input output (I/O) devices 416. The processing unit 404 is responsible for processing the instructions of the algorithm. The processing unit 404 receives commands from the control unit 406 in order to perform its processing. Further, any logical and arithmetic operations involved in the execution of the instructions are computed with the help of the ALU 408.

The overall computing environment 402 can be composed of multiple homogeneous and/or heterogeneous cores, multiple CPUs of different kinds, special media and other accelerators. The processing unit 404 is responsible for processing the instructions of the algorithm. Further, the plurality of processing units 404 may be located on a single chip or over multiple chips.

The algorithm comprising of instructions and codes required for the implementation are stored in either the memory unit 410 or the storage 412 or both. At the time of execution, the instructions may be fetched from the corresponding memory 410 and/or storage 412, and executed by the processing unit 404.

In case of any hardware implementations various networking devices 414 or external I/O devices 416 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 4 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for temporal compression of one or more images, the method comprising:
receiving said one or more images;
performing temporal compression on said one or more images; and
generating one or more compressed images using said temporal compression.

2. The method of claim 1, wherein said one or more images comprises at least one of a still image, a dynamic image, and a sequence of images in a video.

3. The method of claim 1, wherein said one or more images further comprises at least one of one or more related images and one or more unrelated images.

4. The method of claim 1, wherein said temporal compression comprises at least one of a H.264, MPEG2, and MPEG4 scheme.

5. The method of claim 1, wherein size of said one or more compressed images is less than size of said one or more images.

6. The method claim 1, wherein said method further comprises storing said one or more compressed images.

7. A system for temporal compression of one or more images, the system comprising:
a communications module configured to receive said one or more images; and
a controller module configured to perform said temporal compression on said one or more images and generate one or more compressed images.

8. The system of claim 7, wherein said one or more images comprises at least one of a still image, a dynamic image, and a sequence of images in a video.

9. The system of claim 7, wherein said one or more images further comprises at least one of one or more related images and one or more unrelated images.

10. The system of claim 7, wherein said temporal compression comprises at least one of a H.264, MPEG2, and MPEG4 scheme.

11. The system of claim 7, wherein size of said one or more compressed images is less than size of said one or more images.

12. The system claim 1, wherein said system further comprises a storage module configured to store said one or more compressed images.
